(19) United States
(12) Patent Application Publication
(10) Pub. No.: US 2026/0188059 A1
(43) Pub. Date: Jul. 2, 2026

(54) SYSTEM AND METHOD OF OPERATING SYSTEM

(71) Applicant: TOYOTA JIDOSHA KABUSHIKI KAISHA, Toyota-shi (JP)

(72) Inventors: Masato ENDO, Nagoya-shi (JP); Shuhei MANABE, Toyota-shi (JP)

(73) Assignee: TOYOTA JIDOSHA KABUSHIKI KAISHA, Toyota-shi (JP)

(21) Appl. No.: 19/431,947

(22) Filed: Dec. 23, 2025

(30) Foreign Application Priority Data
Dec. 27, 2024 (JP) 2024-232950

(51) Int. Cl. G07C 5/00; G06V 20/59; G07C 5/04; G10L 25/51

(52) U.S. Cl. CPC G07C 5/008; G07C 5/04; G06V 20/597; G10L 25/51

(57) ABSTRACT

A system includes an in-vehicle apparatus mounted in a vehicle, a terminal apparatus used by a driver of the vehicle, and a server apparatus that communicates with the in-vehicle apparatus and the terminal apparatus. The in-vehicle apparatus outputs a notification of a diagnostic result according to the driver's driving to the driver, and transmits first information including the content of the notification to the server apparatus. The server apparatus transmits, to the terminal apparatus, second information for outputting information supplementing the notification to the terminal apparatus.

### CROSS-REFERENCE TO RELATED APPLICATION

This application claims priority to Japanese Patent Application No. 2024-232950, filed on Dec. 27, 2024, the entire contents of which are incorporated herein by reference.

### TECHNICAL FIELD

The present disclosure relates to a system and a method of operating the system.

### BACKGROUND

Technology for diagnosing the state of a mobile object including a vehicle, based on the behavior of the mobile object is known. For example, Patent Literatures (PTLs) 1 to 3 disclose systems that diagnose a vehicle or the like by processing, on a cloud server, information obtained by detecting the behavior of the vehicle or the like.

### CITATION LIST

### Patent Literature

PTL 1: JP 2017-013742 A
PTL 2: JP 2019-131187 A
PTL 3: JP 2021-196678 A

### SUMMARY

When a driver is notified of various diagnostic results related to vehicle driving using artificial intelligence (AI) and the like, there is room for improvement in the certainty of the driver's recognition and understanding of the diagnostic results.

Hereinafter, a system that enables improved certainty of a driver's recognition and understanding of diagnostic results related to vehicle driving will be disclosed.

A system according to the present disclosure includes:
an in-vehicle apparatus mounted in a vehicle;
a terminal apparatus used by a driver of the vehicle; and
a server apparatus configured to communicate with the in-vehicle apparatus and the terminal apparatus,
wherein
the in-vehicle apparatus is configured to output a notification of a diagnostic result according to the driver's driving to the driver, and transmit first information including the content of the notification to the server apparatus, and
the server apparatus is configured to transmit, to the terminal apparatus, second information for outputting information supplementing the notification to the terminal apparatus.

A method of operating a system according to another aspect of the present disclosure is a method of operating a system including an in-vehicle apparatus mounted in a vehicle, a terminal apparatus used by a driver of the vehicle, and a server apparatus configured to communicate with the in-vehicle apparatus and the terminal apparatus, the method including:
outputting, by the in-vehicle apparatus to the driver, a notification of a diagnostic result according to the driver's driving, and transmitting, by the in-vehicle apparatus to the server apparatus, first information including the content of the notification; and
transmitting, by the server apparatus to the terminal apparatus, second information for outputting information supplementing the notification to the terminal apparatus.

The system and the like according to the present disclosure enable improved certainty of a driver's recognition and understanding of diagnostic results related to vehicle driving.

### BRIEF DESCRIPTION OF THE DRAWINGS

In the accompanying drawings:

FIG. 1 is a diagram illustrating an example of a configuration of an information processing system;

FIG. 2 is a sequence diagram illustrating an example of operations of the information processing system; and

FIG. 3 is a flowchart illustrating an example of operations of a server apparatus.

### DETAILED DESCRIPTION

An embodiment will be described below.

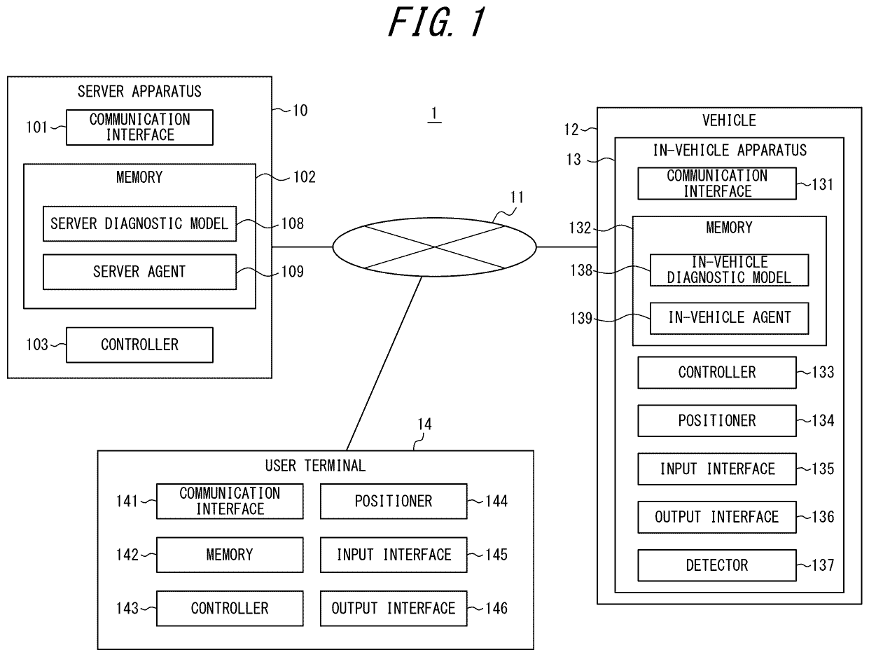

FIG. 1 is a diagram illustrating an example of a configuration of an information processing system according to the embodiment. An information processing system 1 includes at least one server apparatus 10, at least one in-vehicle apparatus 13, and at least one user terminal 14 that are communicably connected to each other via a network 11. The server apparatus 10 is, for example, a server computer that belongs to a cloud computing system or another computing system, and functions as a server that implements various functions. The in-vehicle apparatus 13 is, for example, a navigation system or the like that has a communication function and an information processing function, and is mounted in a vehicle 12. The vehicle 12 is a vehicle such as a passenger car or a commercial vehicle, and part or all of the driving is performed manually by a driver. The vehicle 12 is any type of automobile such as a gasoline vehicle, a Battery Electric Vehicle (BEV), a Hybrid Electric Vehicle (HEV), a Plug-in Hybrid Electric Vehicle (PHEV), or a Fuel Cell Electric Vehicle (FCEV). The user terminal 14 is an information processing terminal used by the driver of the vehicle 12 and is, for example, a smartphone, a tablet terminal, a personal computer (PC), or the like. The user terminal 14 corresponds to “terminal apparatus” of the present embodiment. The network 11 is the Internet, for example, but may also be an ad-hoc network, a LAN, a Metropolitan Area Network (MAN), other networks, or a combination of two or more thereof.

In the present embodiment, the information processing system 1 assists in diagnosing the vehicle 12 and notifying the driver of the diagnostic results. The information processing system 1 includes the in-vehicle apparatus 13 mounted in the vehicle 12, the user terminal 14 used by the driver of the vehicle 12, and the server apparatus 10 that communicates with the in-vehicle apparatus 13 and the user terminal 14. The in-vehicle apparatus 13 outputs a notification (hereinafter referred to as a diagnostic notification) of a diagnostic result to the driver according to the driver's driving, and transmits first information (hereinafter referred to as history information) including the content of the diagnostic notification to the server apparatus 10. The server apparatus 10 transmits, to the user terminal 14, second information for outputting information (hereinafter referred to as supplementary information) that supplements the diagnostic notification to the user terminal 14. Although information that can be communicated to the driver during driving is limited to some extent, the server apparatus 10 causes the user terminal 14 to output the supplementary information, so the driver can check the supplementary information on the user terminal 14, for example, at the end of driving or the like, review the diagnostic result, and deepen understanding. Even in a case in which there is a high probability that the diagnostic notification is not sufficiently conveyed to the driver due to an event that interferes with the diagnostic notification occurring during driving, the driver can ensure the recognition of the diagnostic result through the supplementary information. Therefore, it is possible to improve the certainty of the driver's recognition and understanding of the diagnostic result related to the driving of the vehicle 12.

Next, an example of a configuration of the server apparatus 10 will be described.

The server apparatus 10 includes a communication interface 101, a memory 102, and a controller 103. The server apparatus 10 may be a single computer or may be two or more computers that are communicably connected to each other and operate in cooperation. When the server apparatus 10 is configured with two or more computers, the configuration illustrated in FIG. 1 is arranged as appropriate on the two or more computers.

The communication interface 101 includes one or more interfaces for communication. The interfaces for communication include, for example, a LAN interface. The communication interface 101 receives information to be used for operations of the controller 103, and transmits information obtained by operations of the controller 103. The server apparatus 10 is connected to the network 11 by the communication interface 101, and communicates information with the in-vehicle apparatuses 13 and the user terminal 14 via the network 11.

The memory 102 includes, for example, one or more semiconductor memories, one or more magnetic memories, one or more optical memories, or a combination of at least two of these types, to function as a main memory, an auxiliary memory, or a cache memory. The semiconductor memories are, for example, random access memory (RAM) or read only memory (ROM). The RAM is, for example, static RAM (SRAM) or dynamic RAM (DRAM). The ROM is, for example, electrically erasable programmable ROM (EEPROM). The memory 102 stores information to be used for operations of the controller 103 and information obtained by operations of the controller 103.

The controller 103 includes one or more processors, one or more dedicated circuits, or a combination thereof. The processors are general purpose processors, such as central processing units (CPUs), or dedicated processors, such as graphics processing units (GPUs), specialized for specific processing. The dedicated circuits are, for example, field-programmable gate arrays (FPGAs), application specific integrated circuits (ASICs), or the like. The controller 103 executes information processing related to operations of the server apparatus 10 while controlling components of the server apparatus 10.

The functions of the server apparatus 10 are realized by execution of a control program by a processor included in the controller 103. The control program is a program for causing a computer to execute processing of steps included in operations of the server apparatus 10, thereby enabling the computer to realize functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10, and be read from the medium by the server apparatus 10.

In the present embodiment, the memory 102 stores a server diagnostic model 108 and a server agent 109. The server diagnostic model 108 is an AI model that generates supplementary information suitable for a diagnostic result. The server diagnostic model 108 may be a model that has learned the correspondence between diagnostic results and supplementary information by machine learning, or a rule-based model that derives supplementary information from a diagnostic result. The diagnostic result is the result of determining whether the features of operations by the driver correspond to dangerous driving. The supplementary information includes a past history, a possible cause, an avoidance proposal, or the like, regarding an driving operation diagnosed as dangerous driving. Information constituting the supplementary information may be acquired from another server or the like that provides traffic safety information, for example. The server agent 109 is a dialogue AI module that generates a notification (hereinafter referred to as supplementary notification) to convey the supplementary information from the server diagnostic model 108 to the driver, and has a natural language processing function, a knowledge base regarding diagnostic results and the driver's preferences, and the like.

Next, an example of a configuration of the in-vehicle apparatus 13 will be described.

The in-vehicle apparatus 13 includes a communication interface 131, a memory 132, a controller 133, a positioner 134, an input interface 135, an output interface 136, and a detector 137. These components may be configured as a single control apparatus, as two or more control apparatuses, or with another apparatus such as a control apparatus and a communication device. The control apparatus includes, for example, an electronic control unit (ECU) or the like. The communication device includes, for example, a data communication module (DCM) or the like. The components are communicably connected to each other or to equipment in the vehicle 12, through an in-vehicle network compliant with a standard such as a controller area network (CAN). The in-vehicle apparatus 13 may be configured to include, in part, a device equivalent to the user terminal 14.

The communication interface 131 includes a communication module compliant with a wired or wireless LAN standard, a module compliant with a mobile communication standard such as long term evolution (LTE), 4th generation (4G), or 5th generation (5G), or the like. The in-vehicle apparatus 13 connects to the network 11 via a nearby router apparatus or a mobile communication base station using the communication interface 131, and communicates information with other apparatuses over the network 11.

The memory 132 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 132 functions as, for example, a main memory, an auxiliary memory, or a cache memory. The memory 132 stores information to be used for operations of the controller 133 and information obtained by operations of the controller 133.

The controller 133 includes one or more processors, one or more dedicated circuits, or a combination thereof. The processors are general purpose processors such as CPUs, or dedicated processors such as GPUs that are specialized for specific processing. The dedicated circuits are, for example, FPGAs or ASICs. The controller 133 executes information processing related to operations of the in-vehicle apparatus 13 while controlling components of the in-vehicle apparatus 13.

The functions of the controller 133, such as navigation and multimedia reproduction, are realized by execution of a control/processing program by a processor included in the controller 133. The control/processing program is a program for causing a computer to execute processing of steps included in operations of the controller 133, thereby enabling the computer to realize the functions corresponding to the processing of the steps. That is, the control/processing program is a program for causing a computer to function as the controller 133. Some or all of the functions of the controller 133 may be realized by a dedicated circuit included in the controller 133.

The positioner 134 includes one or more global navigation satellite system (GNSS) receivers. The GNSS includes, for example, Global Positioning System (GPS), Quasi-Zenith Satellite System (QZSS), BeiDou, Global Navigation Satellite System (GLONASS), and/or Galileo. The positioner 134 transmits a positioning result to the controller 133, and the controller 133 calculates positional information on the in-vehicle apparatus 13, that is, the vehicle 12.

The input interface 135 includes one or more interfaces for input. The interfaces for input include, for example, a microphone that accepts voice input, physical keys, capacitive keys, a pointing device, a touch screen integrally provided with a display, or the like. The interfaces for input include an interface with a camera that is provided in the vehicle 12 to capture images of the interior or exterior of the vehicle 12. The camera may be built into the in-vehicle apparatus 13 or may be separate. The input interface 135 accepts input operations of information to be used for operations of the controller 133 by a user such as a driver, voice, or captured images of the driver or the like by a camera, and transmits the accepted information to the controller 133.

The output interface 136 includes one or more interfaces for output. The interfaces for output include, for example, a speaker that outputs sound, a display that outputs images, and the like. The display is, for example, a liquid crystal display (LCD) or an organic electro-luminescent (EL) display. The output interface 136 outputs information to be obtained by operations of the controller 133.

The detector 137 has sensors that detect various events occurring in the vehicle 12, or interfaces with such sensors. The sensors include, for example, sensors that detect the speed, acceleration in a longitudinal direction, acceleration in a lateral direction, deceleration, accelerator operation amount, brake operation amount, steering angle, turn signal lighting time, fuel consumption per unit time, eco mode selection state, odometer value, safety equipment operation information, remaining amounts of engine oil and the like, degree of wear of brake pads, degree of battery degradation, and the like of the vehicle 12. The sensors include radar using millimeter waves, infrared rays, or the like that detects objects around the vehicle 12. The detector 137 transmits vehicle information indicating various states of the vehicle 12 detected by the sensors to the controller 133.

The controller 133 controls each of the communication interface 131, the memory 132, the positioner 134, the input interface 135, the output interface 136, and the detector 137 while exchanging various information with these components, and also controls operations of the vehicle 12. When the vehicle 12 travels, the controller 133 presents various information such as route information necessary for driving to the driver via the output interface 136 to provide a navigation function, and reproduces multimedia to provide video, music, and the like. The controller 133 also partially controls the automated driving of the vehicle 12.

In the present embodiment, the memory 132 stores an in-vehicle diagnostic model 138 and an in-vehicle agent 139. The in-vehicle diagnostic model 138 is an AI model that has learned diagnostic results corresponding to diagnostic target information such as driving operation features or the driver's state. The in-vehicle diagnostic model 138 diagnoses, based on diagnostic target information acquired by the detector 137, whether a driving operation or state corresponds to dangerous driving. The driving operation features includes information indicating control amounts in driving operations or the motion state of the vehicle 12. The control amounts in driving operations include the control amounts of the brake, accelerator, steering, turn signals, and the like. The control amounts include the amount of change in each control amount per unit time. The information indicating the motion state of the vehicle 12 is the moving speed of the vehicle 12, the acceleration in travel and lateral directions of the vehicle 12, the distance to other vehicles detected by radar or captured images of the exterior of the vehicle 12, or the like. The information indicating the driver's state at the time of driving is a captured image, voice, or the like of the driver. The in-vehicle agent 139 is a dialogue AI module that generates a diagnostic notification that conveys a diagnostic result from the in-vehicle diagnostic model 138 to the driver, and has a natural language processing function, a knowledge base regarding diagnostic results and the driver's preferences, and the like.

Next, an example of a configuration of the user terminal 14 will be described.

The user terminal 14 includes a communication interface 141, a memory 142, a controller 143, a positioner 144, an input interface 145, and an output interface 146.

The communication interface 141 includes a communication module compliant with a wired or wireless LAN standard, a module compliant with a mobile communication standard such as LTE, 4G, or 5G, or the like. The user terminal 14 connects to the network 11 via a nearby router apparatus or mobile communication base station using the communication interface 141, and communicates information with other apparatuses over the network 11.

The memory 142 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 142 functions as, for example, a main memory, an auxiliary memory, or a cache memory. The memory 142 stores information to be used for operations of the controller 143 and information obtained by operations of the controller 143.

The controller 143 includes one or more processors, one or more dedicated circuits, or a combination thereof. The processors are general purpose processors such as CPUs, or dedicated processors such as GPUs that are specialized for specific processing. The dedicated circuits are, for example, FPGAs or ASICs. The controller 143 executes information processing related to operations of the user terminal 14 while controlling components of the user terminal 14.

The positioner 144 includes one or more GNSS receivers. GNSS includes, for example, GPS, QZSS, BeiDou, GLONASS, and/or Galileo. The positioner 144 transmits a positioning result to the controller 143, and the controller 143 calculates positional information on the user terminal 14.

The input interface 145 includes one or more interfaces for input. The interfaces for input include, for example, a microphone that accepts voice input, physical keys, capacitive keys, a pointing device, a touch screen integrally provided with a display, a camera that captures images, or the like. The input interface 145 accepts operations for inputting information to be used for operations of the controller 143 and transmits the input information to the controller 143.

The output interface 146 includes one or more interfaces for output. The interfaces for output include, for example, a speaker, a display, or the like. The display is, for example, an LCD or an organic EL display. The output interface 146 outputs information obtained by operations of the controller 143.

The functions of the controller 143 are realized by execution of a control/processing program by a processor included in the controller 143. The control/processing program is a program for causing a computer to execute processing of steps included in operations of the controller 143, thereby enabling the computer to realize the functions corresponding to the processing of the steps. That is, the control/processing program is a program for causing a computer to function as the controller 143. Some or all of the functions of the controller 143 may be realized by a dedicated circuit included in the controller 143.

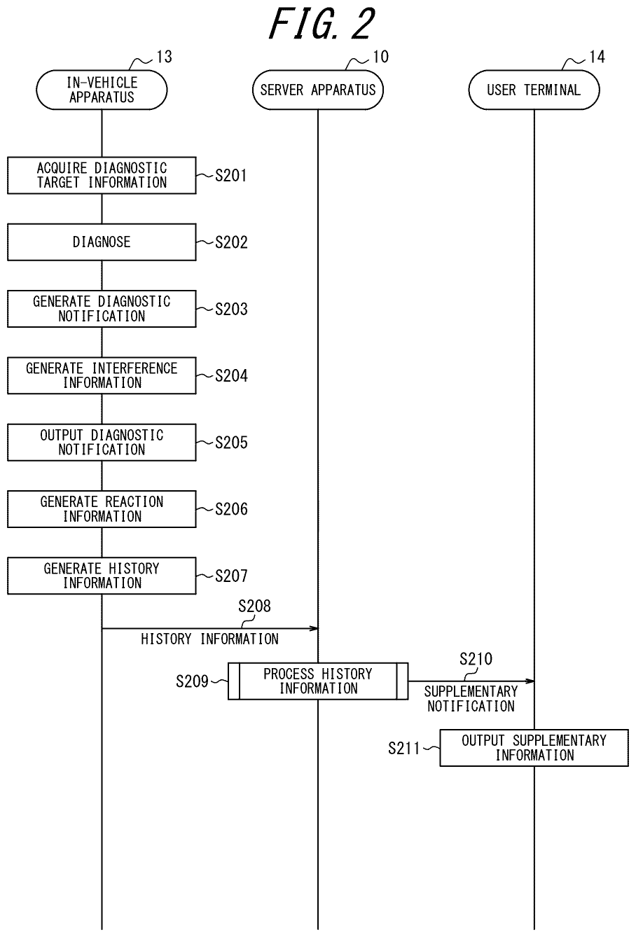

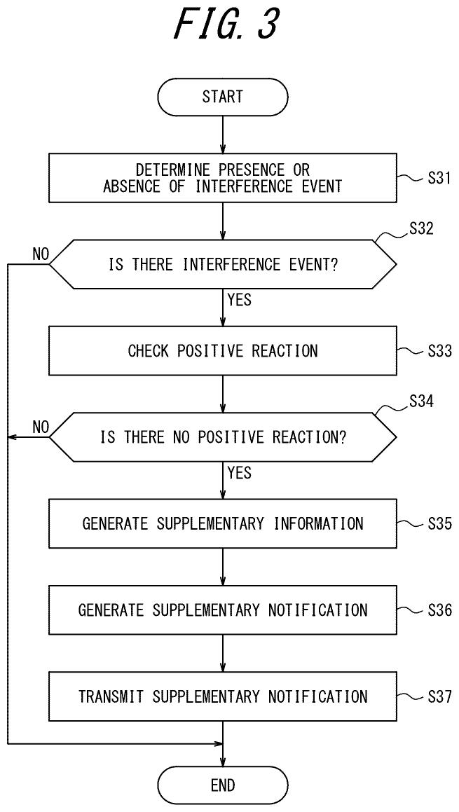

Next, operations of the information processing system 1 will be described with reference to FIG. 2 and FIG. 3.

FIG. 2 is a sequence diagram illustrating an operation procedure of the information processing system 1 according to the present embodiment. FIG. 2 illustrates a procedure in coordinated operations of the server apparatus 10, the in-vehicle apparatus 13, and the user terminal 14. The steps pertaining to the various information processing by the server apparatus 10, the in-vehicle apparatus 13, and the user terminal 14 in FIG. 2 are performed by the respective controllers 103, 133, and 143. The steps pertaining to transmitting and receiving various information to and from the server apparatus 10, the in-vehicle apparatus 13, and the user terminal 14 are performed by the respective controllers 103, 133, and 143 transmitting and receiving information to and from each other via the respective communication interfaces 101, 131, and 141. In the server apparatus 10, the in-vehicle apparatus 13, and the user terminal 14, the respective controllers 103, 133, and 143 appropriately store information to be transmitted, received, or processed, in the respective memories 102, 132, and 142. Furthermore, in the in-vehicle apparatus 13 and the user terminal 14, the controllers 133 and 143 accept input of various information by the respective input interfaces 135 and 145, and output various information by the respective output interfaces 136 and 146.

The steps S201 to S208 of the in-vehicle apparatus 13 in FIG. 2 are executed at any cycles of several tens of milliseconds to several seconds when the vehicle 12 is in motion, for example.

In S201, the in-vehicle apparatus 13 acquires diagnostic target information. The diagnostic target information includes driving operation features and information indicating the driver's state. For example, the controller 133 acquires diagnostic target information including the control amounts of the brake, accelerator, steering, turn signals, and the like, the moving speed, acceleration in travel and lateral directions, and distance to other vehicles of the vehicle 12, and the driver's captured image, voice, and the like, through various sensors and input interfaces provided in the vehicle 12. Each piece of information may be timestamped at the time of acquisition.

In S202, the in-vehicle apparatus 13 performs a diagnosis on the diagnostic target information. In the in-vehicle apparatus 13, the controller 133 executes the in-vehicle diagnostic model 138 to perform a diagnosis on the diagnostic target information. The in-vehicle diagnostic model 138 diagnoses whether driving is dangerous based on information indicating the motion state of the vehicle 12, as driving operation features, such as the control amounts of the brake, accelerator, steering, turn signals, and the like, the moving speed, acceleration in travel and lateral directions, and distance to other vehicles of the vehicle 12, or based on the driver's captured image, voice, and the like.

In S203, the in-vehicle apparatus 13 generates a notification based on the diagnostic result. The controller 133 generates a diagnostic notification to the driver according to the diagnostic result by the in-vehicle agent 139. The in-vehicle agent 139 generates, as a diagnostic notification, a message such as “Danger: Hard Braking!”, “Danger: Sudden Start!”, or “Danger: Sharp Steering!” to warn of danger when the driver's driving is diagnosed to include hard braking, rapid acceleration, sharp steering, or the like based on the control amount of braking, acceleration, and the like, and a message such as “Wake Up!” or “Look Ahead!” to encourage alertness and attention when the driver's state is diagnosed to include drowsiness, fatigue, decreased attention, or the like. Alternatively, the diagnostic notification may be flashing of warning light or output of warning sound, in addition to or instead of the message.

In S204, the in-vehicle apparatus 13 generates interference information. The interference information is information indicating an event that may occur in the vehicle 12 and may interfere with the diagnostic notification to the driver. The interference event is, for example, display or sound output of navigation information, road traffic information, or the like, that takes priority over display or sound output of the diagnostic notification. Alternatively, the interference event may be output of music sound in the vehicle 12 that interferes with sound output of the diagnostic notification. The controller 133 generates information indicating the presence of an interference event when the driver is using the navigation system, outputting traffic information, or reproducing multimedia, and information indicating the absence of an interference event otherwise. When an interference even occurs, the controller 133 may include information indicating the type of the interference event in the interference information.

In S205, the in-vehicle apparatus 13 outputs the diagnostic notification to the driver. However, the controller 133 stops displaying the diagnostic notification when information that takes priority over the diagnostic notification is displayed due to the use of the navigation system or output of traffic information. Additionally, the controller 133 stops sound output of the diagnostic notification when information that takes priority over the diagnostic notification is being output as sound.

In S206, the in-vehicle apparatus 13 generates reaction information indicating the driver's reaction to the received diagnostic notification. The reaction information is information indicating whether the driver has recognized the diagnostic notification. The controller 133 acquires capture images and voice information from the input interface, and determines the driver's reaction based on the captured images and voice information. For example, the controller 133 performs any image processing on the captured images to detect the movement of the driver's face. When the driver's nodding motion is detected, for example, the controller 133 determines that the driver has recognized the diagnostic notification, and otherwise determines that the driver has not recognized the diagnostic notification. The controller 133 analyzes the driver's speech based on the voice information and determines whether the speech contains a phrase indicating recognition, such as “yes” or “understood.” When the phrase indicating recognition is contained, the controller 133 determines that the driver has recognized the diagnostic notification, and otherwise determines that the driver has not recognized the diagnostic notification. The controller 133 generates, based on the determination result, reaction information indicating whether the driver has recognized the diagnostic notification.

In S207, the in-vehicle apparatus 13 generates history information. The history information includes the diagnostic result, the diagnostic notification, the presence or absence of output of the diagnostic notification, and when the diagnostic notification has been output, the interference information and the reaction information at the time of output. The controller 133 can execute a process in which an interference event is regarded to have occurred at the time of output of the diagnostic notification when the time difference between the timing of the output of the diagnostic notification and the timing of the occurrence of the interference event is within any reference range (for example, 1 to several seconds).

In S208, the in-vehicle apparatus 13 transmits the history information to the server apparatus 10.

Steps S209 to S210 of the server apparatus 10 in FIG. 2 are executed, for example, at any cycles of one day to several days. That is, after the processing cycles of steps S201 to S208 are executed multiple times by the in-vehicle apparatus 13, the processing cycle of steps S209 to S210 by the server apparatus 10 may be executed once.

In S209, the server apparatus 10 processes the history information. A detailed example of the process of step S209 is illustrated in FIG. 3.

FIG. 3 is an example of an operation procedure of the server apparatus 10 related to the processing of the history information. Each step in FIG. 3 is executed by the controller 103.

In S31, the controller 103 determines the presence or absence of an interference event. The controller 103 determines the presence or absence of an interference event with reference to the interference information included in the history information.

In S32, upon determining that there is an interference event (Yes in S32), the controller 103 proceeds to step S33. Upon determining that there is no interference event (No in S32), the controller 103 ends the procedure in FIG. 3.

In S33, the controller 103 checks a positive reaction. The controller 103 determines the presence or absence of a positive reaction with reference to the reaction information included in the history information.

In S34, upon determining that there is no positive reaction (Yes in S33), the controller 103 proceeds to step S35. Upon determining that there is a positive reaction (No in S32), the controller 103 ends the procedure in FIG. 3.

In S35, the controller 103 generates supplementary information. The controller 103 generates notification information from the diagnostic result included in the history information, using the server diagnostic model 108. For example, the server diagnostic model 108 generates, from the diagnostic result diagnosed as dangerous driving, supplementary information such as a history of past similar driving operations, a possible cause of the dangerous driving operation, and how to avoid the dangerous driving operation.

In S36, the controller 103 generates a supplementary notification. The controller 103 generates notification information from the diagnostic result included in the history information, using the server agent 109. The server agent 109 generates a supplementary notification such as “There were X-time sudden brakes this month,” “The cause of the sudden brakes may be short following distance,” and “Let's keep a safe following distance.”

In S37, the controller 103 transmits the supplementary notification. In response, in step S210 of FIG. 2, the supplementary notification is transmitted from the server apparatus 10 to the user terminal 14. On the other hand, when the procedure in FIG. 3 ends without executing steps S35 to S37 in FIG. 3, that is, when no interference event has occurred (No in S32) and there is a high probability that the diagnostic notification has been conveyed to the driver, or even when an interference event has occurred (Yes in S32) but there has been a positive reaction (No in S34), for example, when the driver has recognized the display or sound of the diagnostic notification even in the presence of music playing, steps S210 and S211 in FIG. 2 are omitted.

Returning to FIG. 2, in S211, the user terminal 14 outputs the supplementary notification to the driver. The message of the supplementary notification may be displayed on a display of the output interface 146 or output as sound through a speaker. The output of such a supplementary notification can contribute to raising the driver's awareness of the tendency toward dangerous driving. Although the amount of information that can be provided to the driver during driving is limited in the in-vehicle apparatus 13, the driver can review own driving tendency later.

Since the server apparatus 10 causes the user terminal 14 to output the supplementary information by the operation procedure as described above, the driver can check the supplementary information on the user terminal 14, for example, at the end of driving or the like, review the diagnostic result, and deepen understanding. Even in a case in which there is a high probability that the diagnostic notification is not sufficiently conveyed to the driver due to the occurrence of an interference event during driving, the driver can ensure the recognition of the diagnostic result through the supplementary information. Therefore, it is possible to improve the certainty of the driver's recognition and understanding of the diagnostic result related to the driving of the vehicle 12.

Cases in which part of the procedure in FIG. 3 is omitted are also included in the present embodiment. For example, regardless of the presence or absence of an interference event, the server apparatus 10 can generate supplementary information and a supplementary notification and transmit the generated supplementary information and supplementary notification to the user terminal 14. Even in such a case, the driver can check the supplementary information on the user terminal 14 at the end of driving or the like, review the diagnostic result, and deepen understanding. In a case in which an interference event has occurred, the server apparatus 10 can generate supplementary information and a supplementary notification and transmit the generated supplementary information and supplementary notification to the user terminal 14, regardless of the presence or absence of a positive reaction. In such a case, there is an increased probability that the diagnostic result has not been conveyed to the driver due to the interference event, but the driver can check the supplementary information on the user terminal 14 at the end of driving or the like, review the diagnostic result, and deepen understanding.

In the above embodiment, processing/control programs that specify operations of the in-vehicle apparatus 13 and the user terminal 14 may be stored in the memory 102 of the server apparatus 10 or in the memory of another server apparatus and be downloaded onto each apparatus via the network 11. The processing/control programs may be stored on a non-transitory recording/storage medium readable by each apparatus, and be read by each apparatus from the medium.

While the embodiment has been described with reference to the

1. A system comprising:
an in-vehicle apparatus mounted in a vehicle;
a terminal apparatus used by a driver of the vehicle; and
a server apparatus configured to communicate with the in-vehicle apparatus and the terminal apparatus,
wherein
the in-vehicle apparatus is configured to acquire the driver's driving operation or the driver's state at time of driving by a detector, output a notification of a diagnostic result according to acquired information to the driver, and transmit first information including content of the notification and information on presence or absence of occurrence of an event interfering with the notification to the server apparatus, and
the server apparatus is configured to cause the terminal apparatus to output second information by transmitting, to the terminal apparatus, the second information for outputting information supplementing the notification to the terminal apparatus.

2. A system comprising:
an in-vehicle apparatus mounted in a vehicle;
a terminal apparatus used by a driver of the vehicle; and
a server apparatus configured to communicate with the in-vehicle apparatus and the terminal apparatus,
wherein
the in-vehicle apparatus is configured to output a notification of a diagnostic result according to the driver's driving to the driver, and transmit first information including content of the notification to the server apparatus, and
the server apparatus is configured to transmit, to the terminal apparatus, second information for outputting information supplementing the notification to the terminal apparatus.

3. The system according to claim 2, wherein
the in-vehicle apparatus is configured to further include, in the first information, information indicating presence or absence of occurrence of an event interfering with the notification at time when the notification has been output, and
the server apparatus is configured to transmit the second information on condition that the event has occurred.

4. The system according to claim 3, wherein the event is output of an image or sound that interferes with the notification.

5. The system according to claim 4, wherein
the first information further includes information indicating the driver's reaction to the notification, and
the server apparatus is further configured to transmit the second information on condition that the reaction is in a predetermined manner.

6. The system according to claim 5, wherein the information indicating the driver's reaction is the driver's captured image and/or the driver's spoken voice.

7. The system according to claim 2, wherein information supplementing the diagnostic result includes information indicating an analysis of the driving.

8. The system according to claim 2, wherein the in-vehicle apparatus comprises a diagnostic model configured to derive the diagnostic result using information corresponding to the driver's driving, the information being acquired from the vehicle.

9. A method of operating a system including an in-vehicle apparatus mounted in a vehicle, a terminal apparatus used by a driver of the vehicle, and a server apparatus configured to communicate with the in-vehicle apparatus and the terminal apparatus, the method comprising:
outputting, by the in-vehicle apparatus to the driver, a notification of a diagnostic result according to the driver's driving, and transmitting, by the in-vehicle apparatus to the server apparatus, first information including content of the notification; and
transmitting, by the server apparatus to the terminal apparatus, second information for outputting information supplementing the notification to the terminal apparatus.

10. The method according to claim 9, wherein
the in-vehicle apparatus is configured to further include, in the first information, information indicating presence or absence of occurrence of an event interfering with the notification at time when the notification has been output, and
the server apparatus is configured to transmit the second information on condition that the event has occurred.

11. The method according to claim 10, wherein the event is output of an image or sound that interferes with the notification.

12. The method according to claim 11, wherein
the first information further includes information indicating the driver's reaction to the notification, and
the server apparatus is further configured to transmit the second information on condition that the reaction is in a predetermined manner.

13. The method according to claim 12, wherein the information indicating the driver's reaction is the driver's captured image and/or the driver's spoken voice.

14. The method according to claim 9, wherein information supplementing the diagnostic result includes information indicating an analysis of the driving.

15. The method according to claim 9, wherein the in-vehicle apparatus comprises a diagnostic model configured to derive the diagnostic result using information corresponding to the driver's driving, the information being acquired from the vehicle.
